(19) United States
(12) Patent Application Publication
(10) Pub. No.: US 2009/0191529 A1
(43) Pub. Date: Jul. 30, 2009

(54) Video game-based, immersive, advanced burn care educational module

(76) Inventors: David W. Mozingo, Gainesville, FL (US); William G. Cance, Orchard Park, NY (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/321,927

(22) Filed: Jan. 26, 2009

Related U.S. Application Data
(60) Provisional application No. 61/023,269, filed on Jan. 24, 2008.

(51) Int. Cl. A63F 9/24; G09B 23/28

(52) U.S. Cl. 434/262; 463/43

(57) ABSTRACT

A video game-based medical simulation is provided. Disclosed embodiments pertain to mass-casualty simulation for burn disaster training. Game-play exercises direct a player through a mass-casualty event where triage management and patient assessment are tested, and then follow the player to a Burn Center where resuscitation through patient monitoring, reassessment, and managing are tested for the critical hours/days of recovery. Complication loops are included in the game system to provide random application of variation in patient response. The complication loops can insert semi-randomness of critical complication occurrences into the game such that patient simulation may vary each time the game is played.

### CROSS-REFERENCE TO RELATED APPLICATION(S)

This application claims the benefit of U.S. Provisional Application Ser. No. 61/023,269, filed on Jan. 24, 2008, which is hereby incorporated by reference in its entirety, including all tables, figures, and references.

### BACKGROUND

Currently, most burn care treatment education is conducted in burn centers where trauma surgeons, nurses and ancillary staff work for weeks to months to obtain the breadth of information that enables them to provide trauma/critical care services.

With the advent of virtual and graphical simulations, education and training is now possible in a variety of medical fields using simulated environments. However, most medical simulations provide a simulated patient that requires the same interactions due to the same symptoms every time the game or simulation is played. The repetitive simulation is adequate for rote training, but does not necessarily provide simulations for changing and challenging scenarios.

Accordingly, there is a need in the art for an education and training simulation capable of providing advanced burn care and trauma education.

### BRIEF SUMMARY

The subject invention provides a video game-based mass-casualty event simulator. Embodiments of the present invention can be provided as an internet web-based model that can be exported and accessed by, for example, a physician or nurse. The mass-casualty event simulation can be a medical simulation that provides burn disaster training for immersive medical education programs.

An embodiment of the present invention provides a technical education program that can provide trauma surgeons, trauma nurses and ancillary personnel with the information necessary to care for thermally injured patients in the event of a mass-casualty burn event.

Embodiments of the present invention combine video game-based educational technologies with patient triage scenarios and intensive care unit (ICU) management. In addition, immersive patient care instructions and surgical demonstrations can also be included. In embodiments of the present invention, feedback is provided, including using scoring systems based on treatment accuracy and timeliness.

Advantageously, embodiments of the present invention include a semi-random assignment of complications occurring during the course of patient care. The semi-randomness of critical complication occurrences allows the simulation to vary each time the game is played.

In addition, portions of the simulation according to an embodiment of the present invention can include training for an electronic intensive care unit, where patients are centrally monitored using information panels.

Specifically exemplified herein is a video game-based simulation of advanced burn care for medical training. This video game-based simulation is particularly useful for training healthcare professionals including physicians and nurses. It will be clear, however, from the descriptions set forth herein that the video game-based simulation of the subject invention finds application in a wide range of medical specialties ranging from pre-hospital care to advanced practitioner programs. In addition, patient populations and target audiences include, but are not limited to, pre-medical, medical and graduate medical education, pre-nursing, nursing and continuing nursing education as well as all ancillary fields in medicine.

### BRIEF DESCRIPTION OF THE DRAWINGS

The file of this patent contains at least one drawing executed in color. Copies of this patent with color drawings(s) will be provided by the Patent and Trademark Office upon request and payment of the necessary fee.

FIG. 1 shows a game flow for a burn center according to an embodiment of the present invention.

FIG. 2 shows a communicator interface according to an embodiment of the present invention.

FIGS. 3A-3D show screens of a user interface for a video game-based simulation according to an embodiment of the present invention.

### DETAILED DISCLOSURE

Embodiments of the present invention provide a video game-based medical simulation. Specific embodiments relate to a mass-casualty simulation for burn disaster training.

Embodiments of the present invention can utilize current game simulation and game technology to provide extremely immersive, engaging environments with situations for purposes of medical training. By logging into secure servers and participating in predesigned learning exercises using game design methodologies, a player can experiment and experience medical situations leading to developing skill sets necessary for trauma care situations.

Embodiments of the present invention can be used to provide an interactive training application for training trauma surgeons, nurses, and ancillary staff for several areas, including, but not limited to, triage procedures, initial care, surgical management, pain management, wound care, post-operative nursing care, and psychological considerations. According to one embodiment, the training materials can be accessible via web-based learning platforms designed to train medical personnel through use of virtual environments. The simulation according to the present invention can support a learning platform that dynamically responds to situations based on decisions and input by a user. In addition, a random application of variation in patient response provides non-repetitive play and learning.

A specific embodiment of a Burn Center training simulation can provide scenario-based learning and training exercises designed to immerse players into real world situations by, for example, treating burn victims at primary triage locations as well as providing secondary care over the first 24-36 hours in a burn center.

Although a Burn Center simulation is described herein, the simulation program and database is adaptable to many other patient care scenarios.

The game-play of a Burn Center game according to the present invention simulates real life situations and scenarios. In one game, the play begins with a violent event where the player, in the role of a medical responder, can manage a Triage scenario of multiple injured victims. By analyzing circumstances in each scenario and making decisions, the player can manage the life support of each patient through transportation to a hospital and post 36 hours of care. The game can allow a player to raise in rank within the hospital staff and eventually complete training exercises necessary to support the proper care of burn patients.

Goals can be built into the game and communicated to players as objectives that must be met in order to successfully complete certification and win the game. In a specific embodiment, the game can include two chapters. In each chapter, the player must complete specific tasks, such as assessing patients' conditions, determining body percent burn, and sorting patients for care and proper treatment. After each goal is achieved, the player can be prompted via text or in-game audio and visual cues as to what their next goal is.

In one embodiment, the two chapters of the game can be a Triage chapter and a Resuscitation chapter. In the Triage chapter of the game, patients will be at various locations of a chaotic scene where multiple explosions have taken place. The chaotic scene can be, for example in an urban subway tunnel. On the game screen, some patients appear to be lying about without movement or walking around in a daze as blood is flowing from open wounds, while other patients may be partially trapped underneath rubble from the event that just occurred. Through the use of in game User Interface (UI) screens, it is the player's task to follow the set procedures in order to treat the patients' life threatening problems, analyze body percent burns and sort patients for treatment and transport.

As part of the Resuscitation chapter of the game, the player can assume the role of a primary care provider in, for example, a burn center where various burn patients have been transported from the event. It will be up to the player to monitor, reassess the patient and manage care over the next 36 hours for a select number of burn patients. According to embodiments of the present invention, the 36 hours game-time can take, for example, 10-60 minutes of a player's time. According to a preferred embodiment, a 36 hour loop of game-time is provided in a 1 hour simulation. During the 36 hour loop, complications are introduced into the situation. In an embodiment of the present invention, complication loops are programmed to occur randomly. The complication loops can include variations in the frequency that a patient gets a complication. These complications and other forms of complication loops can utilize a database of medical conditions, symptoms and interactions. The software code of the complication loops can access the database as desired for the program to provide random and/or non-repetitive complications.

During the resuscitation chapter, patients may experience a variety of complications. For example, the patients may stop breathing for some unknown reason or have an adverse reaction to medication given. It will be up to the player to determine how to handle each situation. In addition, a player can be provided with training for the use of an electronic ICU, which enables a practitioner to monitor a number of patients from a single location separate from the patients.

In one embodiment, the simulation game can include at least twelve scenarios with at least twelve patients running on complication loops. This can provide a random aspect to complications a player faces during each game. The random aspect inhibits a player from assuming that a particular patient will have the same complications and problems as occurred in a previously played game. This can enable a more challenging learning experience.

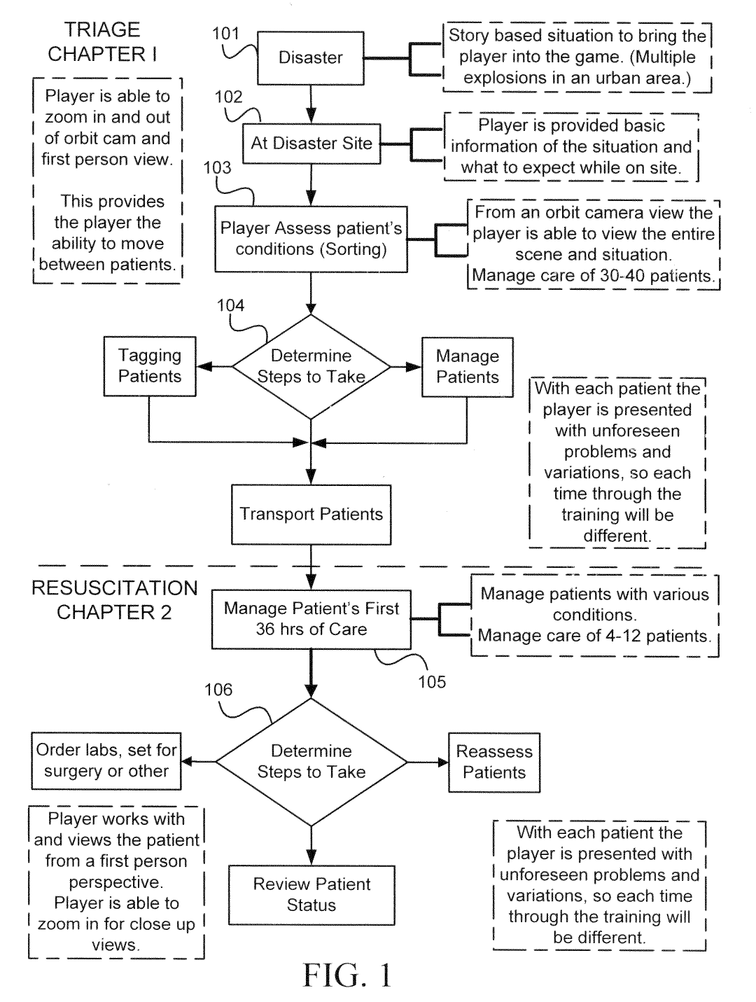

FIG. 1 shows an embodiment of a Burn Center game flow: The first chapter is Triage. A player is able to zoom in and out of orbit cam and first person view. This provides the player the ability to move between patients. The Triage chapter begins with the Disaster (101). The disaster is the story based situation used to bring the player into the game. For example, the disaster can be multiple explosions in an urban area. Then, at the disaster site (102), the player is provided with basic information of the situation and what to expect while on site. Once at the site, the player can assess patients' conditions (103), which is also called sorting. From an orbit camera view, the player is able to view the entire scene and situation. In one embodiment, the player will need to manage the care of 30-40 patients. The player must determine the steps to take (104), including tagging patients, managing patients, and transporting patients. With each patient, the player is presented with unforeseen problems and variations, so each time through the training will be different. As described above, the unforeseen problems and variations can be the result of complication loops in the system.

Once the triage chapter is completed, the second chapter may begin. The second chapter is the Resuscitation chapter. The Resuscitation chapter begins with managing patients' first 36 hours of care (105). The player must manage patients with various conditions. For example, the player may be required to manage the care of 4-12 patients. The player must determine what steps to take (106), including ordering labs, setting the patient for surgery or other steps, reassessing the patients, and reviewing patient status. The player works with and views the patient from a first person perspective. The player is able to zoom in for close-up views. With each patient the player is presented with unforeseen problems and variations determined by the complication loops, so each time through the training will be different. For example, a patient may develop a pneumothorax after a central venous catheter insertion. Also, some patients may require more fluid than predicted by the resuscitation formulas due to other injuries or preexisting medical conditions.

A variety of clinical scenarios can be provided with a range of patient age, severity of burn injury, presence of co-morbidities and associated traumatic and smoke inhalation injuries.

The exercise can represent a mass-casualty incident in which, for example, 30-40 patients are injured. Patients can demonstrate a range of injuries from relatively minor wounds to being pronounced dead at the scene. Traumatic injuries in addition to burn injuries will be present in some patients. For the Resuscitation management portion, in one embodiment, 4-12 patients ranging from minor to severe in injury status are selected from the initial triage scenarios to teach detailed patient management during the first 36 hours of care. Players can examine each patient through visual and audio feedback mechanisms.

According to embodiments of the present invention, the Resuscitation portion can include a representation of an electronic ICU. The electronic ICU is a centralized maintaining area where a practitioner can monitor a number of patients. For the representation of the electronic ICU, a player can monitor a number of panels representing the patients under the player's care. The player can watch all panels at once. In one embodiment, by clicking a monitor, it is possible to see information, including vital signs, of a patient. In a further embodiment, by double-clicking a monitor, the player can enter the patient's room to examine and clinically respond to the patient.

In another embodiment, the game can use a theme park setting where, for example, there has been an explosion on a rail. In the Triage chapter of the game, a number of patients (such as between 5 and 10 people) can be at each scene. The image on the screen can display patients moving with fire and smoke in the background. For medical response communication, a player can move a curser over a patient to receive vital signs and patient history. In one embodiment, a click of a mouse on a patient can cause the patient to lie down. The player can then decide the appropriate clinical response. Here, the exercise can be timed and the player is rated on the ability to treat the patients in the correct order. In the Resuscitation chapter, the player can assume the roles of therapists, ICU nurses, and surgeon practitioners in charge of, for example, 2, 6, or 12 beds of patients.

Because the Burn Center embodiment is a simulation game, its world exists and is on-going from the moment it starts—events are unfolding, decisions are being made, lives are being saved or lost. The player can receive a constant feeling of pressure from a series of chaotic training scenarios. Information, status and issues are presented via text and audio feedback from patients and medical personnel on site, text messages and calls received from hospital staff as well as arriving transport personnel. Each piece of information, scenario or situation presents decision points—right or wrong. It is the player's job to cull the information, act on the critical issues and set appropriate steps for patient's care. This intense activity can be accomplished via a unique set of UI screens.

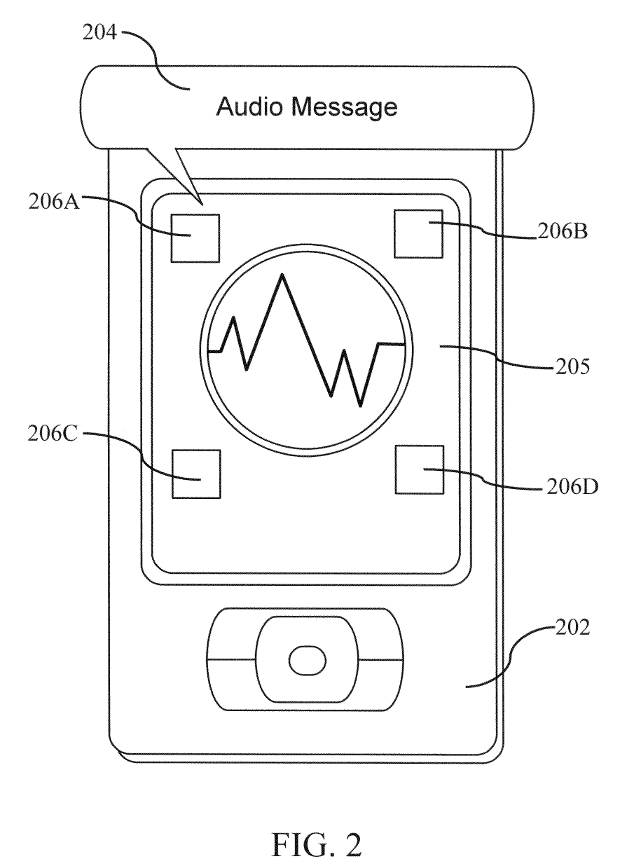

According to an embodiment of the present invention, the user interface can include a communicator interface. The communicator interface allows a player to keep in contact with hospital staff, emergency medical technicians (EMTs) and other medical response units. Referring to FIG. 2, the communicator interface 202, or medical response (MR) communicator, can appear in the form of a personal digital assistant (PDA) that combines video, cell phone, text messaging, a database, and a patient tracking system. The communicator interface 202 can play audio information 204 and includes a display screen 205 for presenting information visually. Various functions of the communicator interface 202 can be accessed by selecting icons 206A-D on the display screen 205, for example, treatment icon 206D.

The MR communicator can be a game play UI that allows a player to access and collect information normally found in various places when treating a patient. As one use, if a player desires a refresher with respect to the last step completed with a patient, the player can click a button on the MR communicator screen and the information will appear on the MR communicator screen with the patient's vital status and next set of options on the analysis interface. As another use, if a player needs to find out what hospitals in the area have availability, then the player can send a message to the hospital staff from the ‘PDA’ and get a complete list of every location, by number and types of injuries that they can accommodate.

In one embodiment, as a player moves over each patient, general information is displayed and the patient is highlighted to indicate which patient the information refers to. As the player enters analysis mode, display icons for multiple options are presented. In one embodiment example, it is possible to review a patient's airway access, apply medical supplies, assess burn area, sort and tag, request medical support assistance, and determine transport method. Of course, the options are not limited to those listed.

Analysis mode can provide a display showing the patient from a first person perspective with vital state and visual reference. Each icon in analysis mode represents options to the player. The player can then decide the correct steps in different situations, each altering the patient's physical state.

The graphical look of the game can include a variety of styles and media. According to a preferred embodiment, the general style of the game balances between 2-dimensional and 3-dimensional art and video reference. In addition, the design allows for a real-time strategy and adventure feel. Realistic textures can be included for appropriate reference and decision outcomes. Some analysis procedures may require zooming in on the patient and viewing exposed organs or wounds via a ‘ highlight-access’ option.

In one embodiment, the graphical environments are realistic and stylized with certain exaggerated features to aid in making navigation straight forward. Patients can be highlighted along with key locations or elements in the game world, as well as other manageable resources and hospital employees. Special UI overlays can fade in so that a player can see at a glance, the overall condition of a patient, thereby helping the player to determine who to assist first and what resources might be required to most effectively handle each situation. The MR communicator can be an example of a special UI overlay that can fade in to view of a player.

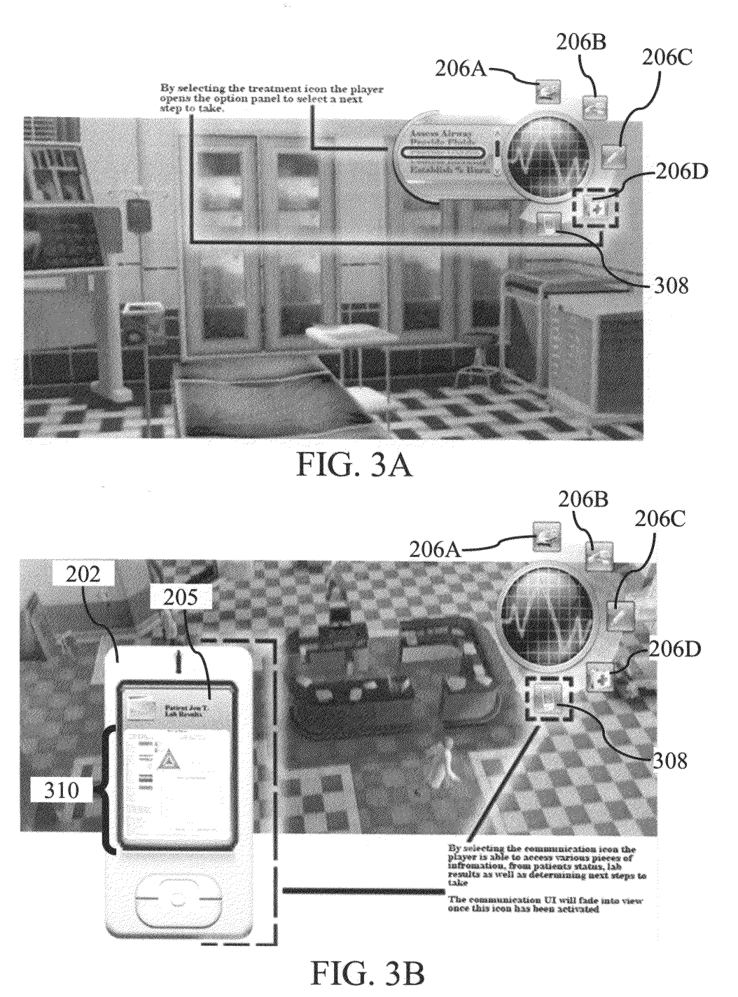

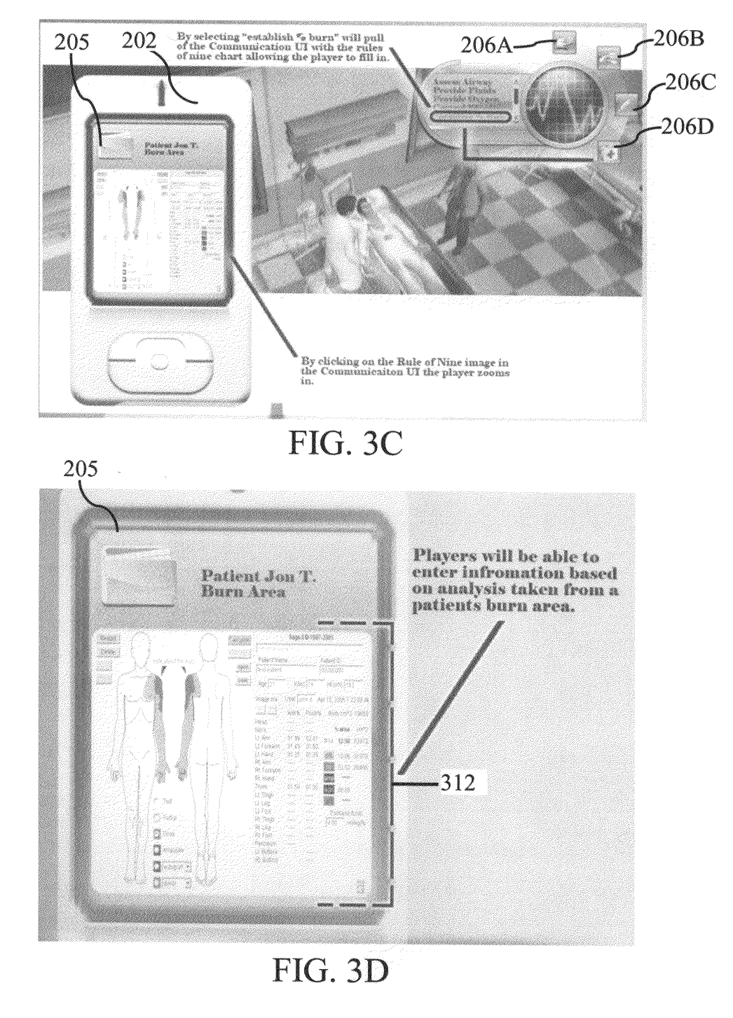

Referring to FIG. 3A, a first person mode screen can provide a first person point of view of a room or patient. By selecting a treatment icon 206D, the player can open an option panel to select a next step to take. FIG. 3A shows a selection of “Provide Oxygen” after a Red Cross-type icon is selected.

Referring to FIG. 3B, a survey mode screen is also provided. This allows a player to view a large scene. As shown in FIG. 3B, by selecting the communication icon 308, a player is able to access various pieces of information from the MR communicator UI. The information can include, for example, patient status, lab results, and next step determination. In one embodiment, the MR communicator can fade into view upon activation of the icon. Here, the MR communicator 202 is shown presenting lab results 310 via its display screen 205.

Referring to FIGS. 3C and 3D, by selecting “establish % burn” from the treatment icon panel list, the MR communicator 202 can be viewed and a player can fill in a Rules of Nine chart. In one embodiment, as shown in FIG. 3D, by clicking on the MR communicator's display screen 205, the player can zoom in on an image of the Rules of Nine Chart 312. The player can then enter information into the chart based on the player's analysis of the patient's burn area.

In a preferred embodiment, as a patient's condition changes, the character's graphics can change to reflect a result of a procedure.

In one embodiment, early in the game the player will experience flashbacks of days back at medical or nursing school, which is an in-game tutorial system. These flashbacks will take the form of images with basic animations to help walk players through the different elements of the game simulation—when and how to make decision calls, use the scalpel, apply bandages, move a patient, assess burn areas, and other options available through use of the UI screen. The game can reward a player for how accurate they assess a patient and apply correct decision outcomes by lowering the patient's heart rate to a point where vitals are stable. In addition, a player's accuracy is calculated after all scenarios have been completed and all patients are taken care of with a variety of attributes.

The game ranks points based on completing scenarios with accuracy. The points can include ratings based on correct, incorrect, or possible actions. The ratings can allow a player to understand how to improve on a completed scenario. A player's practical application of acquired knowledge can be monitored. In certain embodiments, the game simulation can monitor specific areas of interest, weakness, or skill sets. Metrics for learning progress can be generated based on time for both individuals and large-scale learning trends.

In one embodiment, the game waits until the end of each chapter to provide final assessment to the player with respect to successful verses unsuccessful decisions that were made during each step in working on patients. In a further embodiment, teaching notes can be provided at the end of the game or a scene to provide information on additional actions, treatments, and conditions. The teaching notes can include attached articles on suggested treatment plans and links to web sites.

Detailed feedback can also be provided at the end of the game so as to not interrupt the momentum of the game. Players can be measured on accuracy and speed in various situations and assigned a rank that equates to a player's overall performance.

In one embodiment example, a player will need to maintain a 95% or higher rating combined for each of the following areas in order to pass the Triage chapter: proper decisions based on situation, burn assessment percent, mini game calculations, correct tagging based on patient assessment and conditions, and correct type of transport. In addition, a player will need to maintain a 98% or higher rating combined in each of the following areas in order to pass the Resuscitation chapter: correctly reassess patient conditions, proper patient care management, and proper data analysis.

In a further embodiment, once a scenario has been completed and the patient is safe from injuries, players can attempt the exercise again without the storyline via a training mode. In an embodiment of the training mode, players can come back and retest scenarios under various conditions to determine possible outcomes. Because certain embodiments of the game rate players based on their accuracy and speed, the training mode can allow a player to challenge themselves or against others in trying to rise up in the ranks and points with each training simulation. Therefore, even when the story mode is completed, players can continue to perform the exercises until the highest ranking is achieved for each training scenario.

Further embodiments of the present invention can include videos of burn surgery or other patient treatments, as well as videos of didactic lecture material as training elements integrated alongside Triage and Resuscitation game simulations.

As one skilled in the art will appreciate, embodiments of the subject invention can be embodied as, among other things: a method, system, or computer program. Accordingly, the embodiments can take the form of a hardware embodiment, a software embodiment, a firmware embodiment or an embodiment combining software, hardware, and firmware. In an embodiment, the subject invention takes the form of a computer program that includes computer-useable instructions embodied on one or more computer-readable media.

Computer-readable media include both volatile and nonvolatile media, removable and nonremovable media, and contemplate media readable by computers and various other electronic devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention can be practiced in distributed-computing environments where tasks are performed by remote-processing devices that are linked through a communications network. In a distributed-computing environment, program modules can be located in both local and remote computer-storage media including memory storage devices.

A specific embodiment of the present invention can utilize Flash technology for design content, animation, and playback.

Certain embodiments of the present invention can be accessible from the internet through web based learning platforms and/or disks such as DVDs or CDs.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A method for medical training using a video game-based mass-casualty simulation, the method comprising:
presenting to a user via a first user interface patient information representing a current status of a hypothetical victim of a mass-casualty event;
randomly selecting a complication from a database;
updating the hypothetical victim's patient information based on the selected complication and any user interaction or inaction; and
presenting the updated patient information to the user in order to show a changed status of the hypothetical victim.

2. The method of claim 1, further comprising:
presenting a set of treatment options to the user via a second user interface; and
updating the patient information based on a user selected treatment option.

3. The method of claim 1, further comprising providing feedback to the user based on accuracy and timeliness of a treatment decision.

4. The method of claim 3, wherein the feedback is provided via an award of points for correct decisions.

5. The method of claim 3, wherein the feedback comprises teaching notes.

6. The method of claim 1, wherein the database comprises information relating to medical conditions, symptoms, and interactions.

7. The method of claim 1, wherein the complication comprises an unexpected response of the hypothetical victim to a user treatment decision.

8. The method of claim 1, wherein the complication comprises a pre-existing medical condition.

9. The method of claim 1, further comprising providing a secondary layer of complication controlling the randomly selecting of the complication from the database, wherein the secondary layer of complication comprises varying the frequency of the randomly selecting of the complication from the database.

10. The method of claim 1, wherein the first user interface comprises a graphical representation from a first person point of view.

11. The method of claim 1, wherein the first user interface comprises a graphical representation of a communicator displaying at least some of the patient information.

12. The method of claim 11, wherein the communicator displays test results related the hypothetical victim.

13. The method of claim 11, wherein the communicator displays an image of a human body representing the victim for allowing the user to quantify a percentage burn of the hypothetical victim by clicking or indicating on the image of the human body.

14. One or more computer-readable media having computer-useable instructions embodied thereon configured to run a video game-based simulation for training a user to care for patients injured by a burn disaster, the simulation comprising:
a disaster scenario wherein a plurality of patients are injured at a disaster site;
a triage chapter taking place at the disaster site, the triage chapter comprising scenarios for the user to make decisions to assess, sort, and transport to one or more health care facilities, some or all of the plurality of injured patients; and
a resuscitation chapter taking place at one of the health care facilities, the resuscitation chapter comprising scenarios for the user to make decisions to treat and reassess a subset of the plurality of injured patients from the triage chapter.

15. The media of claim 14, wherein the simulation further comprises a feedback module wherein the user's decisions are rated based on accuracy and timeliness.

16. The media of claim 14, wherein the simulation further comprises a tutorial module in which instructional images are presented to the user to help the user make decisions regarding patient care.

17. The media of claim 16, wherein the instructional images are presented in the form of flashbacks comprising memories of instruction provided in a school setting.

18. The media of claim 14, wherein complications are randomly selected and applied to the plurality of injured patients.

19. The media of claim 14, wherein some of the plurality of patients are injured with thermal injuries at the disaster site, and wherein the one of the health care facilities comprises a burn center.

20. The media of claim 14, wherein the one of the health care facilities comprises an electronic intensive care unit; and
wherein the resuscitation chapter involves monitoring a group of patients via information panels located in a single location separate from each of the patients in the group of patients, the group of patients comprising at least some of the subset of the plurality of injured patients.

21. One or more computer-readable media having computer-useable instructions embodied thereon for performing a method for medical training using a video game-based mass-casualty simulation, the method comprising:
presenting to a user via a first user interface patient information representing a current status of a hypothetical victim of a mass-casualty event;
presenting a set of treatment options to the user via a second user interface;
randomly selecting a complication from a database;
updating the hypothetical victim's patient information based on the selected complication and any user interaction or inaction; and
presenting the updated patient information to the user in order to show a changed status of the hypothetical victim.

22. The media of claim 21, wherein the method further comprises providing feedback to the user based on accuracy and timeliness of a treatment decision.

23. The media of claim 21, wherein the database comprises information relating to medical conditions, symptoms, and interactions.

24. The media of claim 21, wherein the method further comprises providing a secondary layer of complication controlling the randomly selecting of the complication from the database, wherein the secondary layer of complication comprises varying the frequency of the randomly selecting of the complication from the database.

25. The media of claim 24, wherein the method further comprises providing a tertiary layer of complication varying the number of hypothetical victims to which the randomly selecting of the complication from the database is respectively applied.
